(19) United States
(12) Patent Application Publication
(10) Pub. No.: US 2020/0097649 A1
(43) Pub. Date: Mar. 26, 2020

(54) FRAUD PREVENTION METHOD FOR INFORMATION PROCESSING DEVICE

(71) Applicant: NIDEC SANKYO CORPORATION, Nagano (JP)

(72) Inventor: Tsutomu BABA, Nagano (JP)

(21) Appl. No.: 16/582,035

(22) Filed: Sep. 25, 2019

(30) Foreign Application Priority Data
Sep. 26, 2018 (JP) 2018-180046

(51) Int. Cl. G06F 21/54; G06F 21/60; G06F 21/44

(52) U.S. Cl. CPC G06F 21/54; G06F 2221/033; G06F 21/44; G06F 21/602

(57) ABSTRACT

An information processing device may include a data memory configured to store a security datum; a program memory configured to store a processing program; and a processor configured to execute the processing program. The processing program requires the security datum to execute the processing program. The security datum is stored at a memory address in the data memory. The program memory is configured to store a reference address table linking the security datum with the memory address in the data memory at which the security datum is stored. The processor is configured to, when executing the processing program, access the reference address table to identify the memory address of the security datum corresponding to the processing program, access the required security datum at the memory address, and execute the processing program. The reference address table is different from a second reference address table in a second information processing device.

### CROSS REFERENCE TO RELATED APPLICATION

The present application claims priority under 35 U.S.C. § 119 to Japanese Patent Application No. 2018-180046 filed Sep. 26, 2018, the entire content of which is incorporated herein by reference.

### FIELD OF TECHNOLOGY

The present invention relates to a fraud prevention method for an information processing device.

### BACKGROUND

Financial terminals such as ATMs require security. Therefore, in an information processing device such as a card reader, which is installed in a financial terminal, a security function is ensured by a firmware (Patent reference 1).

### Patent Reference

[Patent Reference 1] Unexamined Japanese Patent Application 2016-186744 Publication

In general, when a device manufacturer provides a device such as a card reader with a security function for data protection installed to a customer such as a financial terminal maker, product delivery is often made in the following two stages. The device manufacturer provides in a first stage a test machine on which a firmware having an internal data reference function for debugging is installed. The customer implements various debugs and tests on the test machine spending between several months and year or more if necessary. Upon completion of the customer's evaluation, the device manufacturer provides the customer a mass-produced device in which a real execution firmware specified for market use is installed. In the debug/test stage, if the customer discovers malfunction of the card reader or discovers a necessary fix on the matching with a host system, the customer requests the device manufacturer to make a repair. The device manufacturer repairs the firmware for the card reader based on the request from the customer and provides the customer a repaired download file. The repaired file is delivered to the customer usually through email or directly through an USB memory; therefore, if security is low at the time of delivery, there will be a risk of fraud obtaining of the file in the process of email communications or of the repaired download file which is saved in the customer's computer. Therefore, if a person with an evil intent installs an illegally-acquired repaired download file into a financial terminal device, security data will be stolen.

Countermeasures have been provided by programming a command in test firmware for a mass-produced machine to prohibit illegal download or by programming an electronic signature key in a test information processing device; however, illegal acts, despite failure, can be executed again and again against such countermeasures, and therefore, sufficient security cannot be ensured.

### SUMMARY

Considering the above problems, at least an embodiment of the present invention provides a fraud prevention method in an information processing device, in which even when a grogram file is handled under the condition of low security, security data is prevented from being stolen.

To solve the above problems, the present invention is a fraud prevention method used in an information processing device having a program area, in which a program is installed, and a data area, in which security data is stored; wherein the storage positions of the security data in the data area differ in an information processing device which is operated in any situations except actual operations from one which is actually operated; the program is a test program corresponding to the changes of the security data storage positions.

In the present invention, in the information processing device that is operated in any situations except actual operations, the security data storage positions in the data area have been changed and a test program which corresponds to the changes of the security data storage position is used as the program. Therefore, even if the test program is stolen and the stolen test program is installed in an information processing device which is actually operated, since the security data storage positions [of the original program] are different from those of the test program, security data is hard to acquire in an unauthorized manner.

In the present invention, the information processing device which is operated in any situations except actual operations is a test information processing device.

In the present invention, the test program may have an internal data reference function for debug. In this case, the test program may be configured such that the internal data reference function cannot be executed if a machine authentication is not normally finished.

In the present invention, the information processing device may adopt a configuration in which, after the program is installed in the program area, a machine authentication is required to update the program.

In the present invention, the information processing device may adopt a configuration in which, after the program is installed in the program area, a machine authentication is required to start a security function.

In the present invention, the information processing device may adopt a configuration in which the operation thereof is halted when the test program is installed in the program area.

The present invention may adopt a configuration in which said security data contains at least either a key or authentication data for a machine authentication.

In the present invention, the storage positions of security data in the data area are changed and a test program corresponding to the changes of the security data storage position is used as the program in the information processing device which is operated in any situations except actual operations. For this reason, even if the test program is stolen and the illegally-acquired test program is installed in an information processing device which is for actual operations, since the security data storage positions [in the program in the actual operational processing device] are different from those in the test program, the security data is hard to acquire in an unauthorized manner.

### BRIEF DESCRIPTION OF DRAWING

Embodiments will now be described, by way of example only, with reference to the accompanying drawings which are meant to be exemplary, not limiting, and wherein like elements are numbered alike in several Figures, in which:

FIG. 1 is an illustration of an information processing device to which the present invention is applied.

FIG. 2 is an illustration schematically showing the configuration of a firmware part of the information processing device shown in FIG. 1.

FIG. 3 is an illustration schematically showing the configuration of the firmware part when the information processing device of FIG. 1 is a test machine.

FIG. 4 is an illustration showing that a test program is installed in a mass-produced information processing device.

### DETAILED DESCRIPTION

Referring to the drawings, embodiments of the present invention are described. Note that the description below mainly uses a card reader 10 for an information processing device 1.

### (Overall Configuration)

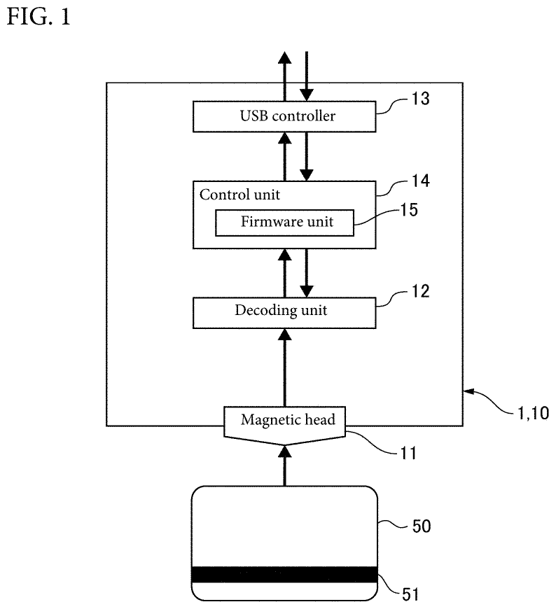

FIG. 1 is an illustration of an information processing device 1 to which the present invention is applied. The information processing device 1 shown in FIG. 1 is a card reader 10 (a device) which is to be used in a financial terminal such as an ATM; the card reader 10 reads information from a card 50 having a magnetic strip 51 on which magnetic information is recorded. For this, the card reader 10 has a magnetic head 11 which detects magnetic data from the magnetic strip 51, a decoding unit 12 which demodulates the result detected by the magnetic head 11 into magnetic demodulated data, an USB controller 13 used to communicate with a host device, and a control unit 14 which administers the card reader 10; the control unit 14 has a firmware unit 15 in which a pre-installed firmware, etc. are saved.

The firmware unit 15 implements necessary processing according to a command input to the card reader 10 from the host device, encrypts data on the card 50 and outputs it to the host device.

### (Configuration of Firmware Unit 15)

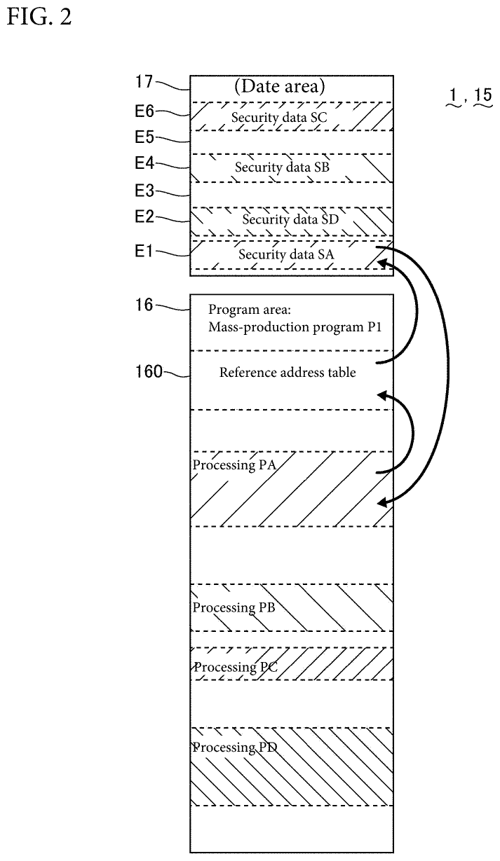

FIG. 2 is an illustration schematically showing the configuration of the firmware unit 15 of the information processing device 1 of FIG. 1. FIG. 2 schematically shows the configuration of the mass-produced information processing device 1 which is actually operated in a financial terminal such as an ATM.

As shown in FIG. 2, the firmware unit 15 of the information processing device 1 has a program area 16 in which a program is installed and a data area 17 in which security data is stored; in the program area 16, a mass-production program P1 is installed to actually operate the information processing device 1 in a financial terminal of a financial institution. Therefore, a mass-production program P1 for implementing each processing (a first processing PA, a second processing PB, a third processing PC and a fourth processing PD) is stored in the program area 16 and, multiple security data (first security data SA, second security data SB, third security data SC and fourth security data SD) used at the time of each processing is stored in the data area 17. The mass-production program P1 runs, referring to the security data stored in the data area 17. Each of the multiple security data (the first security data SA, the second security data SB, the third security data SC and the fourth security data SD) contains at least either a key or authentication data used for a machine authentication. In this embodiment, the first security data SA, the second security data SB, the third security data SC and the fourth security data SD act as a key or authentication data to be used for machine authentication. Note that the multiple security data may be something other than a key or authentication data to be used for machine authentication.

The first security data SA, the second security data SB, the third security data SC and the fourth security data SD is respectively stored at each address (a first address E1, a fourth address E4, a sixth address E6 and a second address E2). Therefore, the program area 16 is provided with a reference address table 160 indicating at which address the security data is stored; the content of the reference address table 160 is shown below.

The content of the reference address table 160:

First address E1—First security data SA

Second address E2—Fourth security data SD

Fourth address E4—Second security data SB

Sixth address E6—Third security data SC

As shown in FIG. 2, therefore, when the first processing PA is implemented in the information processing device 1, for example, the first security data SA, which is associated with the first processing PA, is acquired from the first address E1 in the data area 17, based on the reference address table 160. Other processing is implemented in the same manner.

### (Description of the Condition Under Low Security)

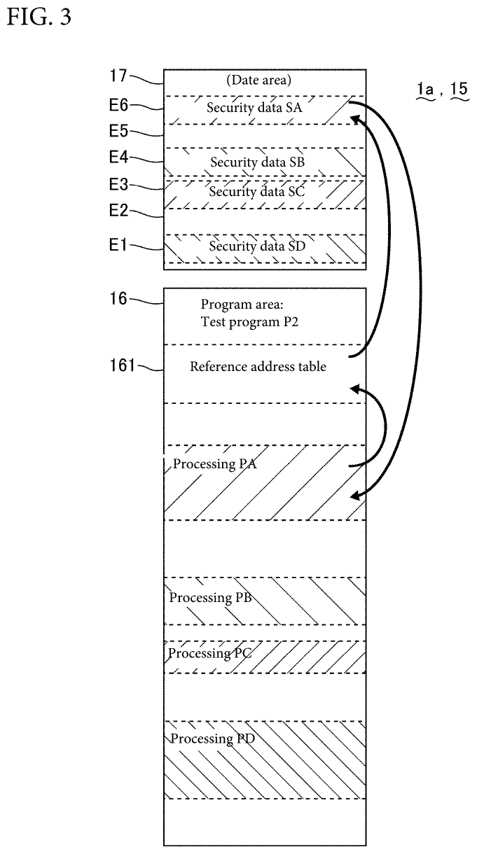

FIG. 3 is an illustration schematically showing the configuration of the firmware unit 15 when the information processing device 1 of FIG. 1 is test [device]. In this embodiment, when the information processing device 1 shown in FIG. 1 is used as an information processing device to be operated in any situations except actual operations (a test information processing device), the storage positions of the multiple security data in the data area 17 are changed as shown in FIG. 3 and a test program P2 which corresponds to the change of the storage positions of the security data is used for the program.

For example, when a device manufacturer that manufactures the information processing device 1 having the configuration shown in FIG. 2 provides an information processing device 1 to a customer such as a financial terminal manufacturer, it [first] provides the customer a test information processing device 1a (FIG. 3 for reference) with a firmware having an internal data reference function for debug installed. The customer implements various kinds of debugs and tests on the test information processing device. When the customer completes evaluations, the device manufacturer [next] provides a mass-produced information processing device 1 with a firmware for actual operations, which is to be set up in market. If the customer finds errors or adjustments needed in connection with a host system during the above process, the customer requests the device manufacturer to repair the firmware. The device manufacturer repairs the firmware based on the request by the customer and provides the customer a repaired download file by email, a direct delivery through USB memory or a delivery by Cloud. If security is low at the time of delivery, there is a risk that the file may be stolen in the process of email transmission or the repaired download file saved in the customer's computer may be stolen.

In this embodiment, then, as shown in FIG. 3, the storage positions of the multiple security data in the data area 17 are changed in the test information processing device 1a , and the test program P2 is corresponded to the changes of the security data storage positions.

More specifically described, in the same manner as the configuration described referring to FIG. 2, programs to implement the processing (the first process PA, the second process PB, the third process PC and the fourth process PD) are stored in the program area 16 of the test information processing device 1a . Also, the multiple security data (the first security data SA, the second security data SB, the third security data SC and the fourth security data SD) is stored in the data area 17.

Note that, in the test information processing device 1a , the multiple security data storage positions in the data area 17 are changed from the positions in an actual processing device. For example, the fourth security data SD, the third security data SC, the second security data SB and the first security data SA are respectively arranged at the first address E1, the third address E3, the fourth address E4 and the sixth address E6 in sequence. Therefore, the content of the reference address table 161 in the test program P2 is as follows.

The content of the reference address table 161:

First address E1—Fourth security data SD

Third address E3—Third security data SC

Fourth address E4—Second security data SB

Sixth address E6—First security data SA

Note that a key-registered flag and an authentication data-registered flag are stored at the same addresses in both the data area 17 shown in FIG. 2 and the data area 17 shown in FIG. 3.

Therefore, when the first processing PA is implemented in the test information processing device 1a , the first security data SA which is to be used for the first processing PA is acquired from the sixth address E6 in the data area 17, based on the reference address table 161. This is the same for other processing.

### (Operation and Effect of This Embodiment)

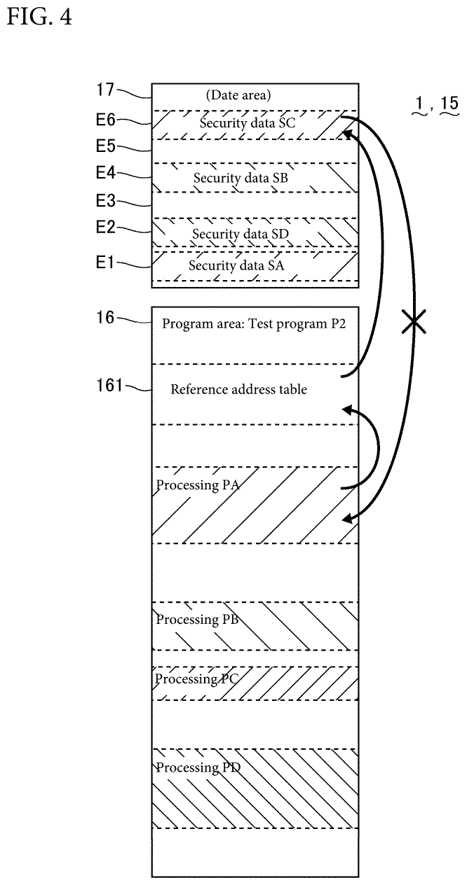

FIG. 4 illustrates the configuration when the test program is installed in the mass-produced information processing device 1. When a person with an evil intent installs a stolen repaired download file (the test program P2) in the information processing device 1 in a financial terminal which is set up in market, the information processing device 1 is configured as shown in FIG. 4.

In the configuration shown in FIG. 4, the content of the reference address table 161 is as follows since the test program P2 is installed in the program area 16.

The content of the reference address table 161:

First address E1—Fourth security data SD

Third address E3—Third security data SC

Fourth address E4—Second security data SB

Sixth address E6—First security data SA

However, in the mass information processing device 1, the security data is stored in the data area 17 in the following manner.

The content of the data area 17:

First address E1—First security data SA

Second address E2—Fourth security data SD

Fourth address E4—Second security data SB

Sixth address—Third security data SC

As shown in FIG. 4, therefore, when the test program P2 is installed in the mass-produced information processing device 1 and the first processing PA is implemented, even if the security data is acquired from the sixth address E6 in the data area 17 based on the reference address table 161, the acquired security data is the third security data SC which is necessary for the third processing PC. Therefore, the mass-produced information processing device 1 to which the test program P2 is installed does not work.

As described, the security data positions are changed between the mass-information processing device 1 and the test information processing device 1a in this embodiment; therefore, the correct security data cannot be acquired even if the internal data reference function for debag for the test program P2 is used. Also, various data cannot be normally output from the mass-produced information processing device 1 if the test program is installed therein; therefore, even if a mass-produced information processing device 1 to which the test program is installed is illegally set up as an ATM, information on a card 50 cannot be acquired in an unauthorized manner. Thus, security is assured on the information processing device 1.

### [Other Embodiments]

The above-described test program P2 may be configured for the internal data reference function not to be run if a machine authentication is not normally finished. According to this configuration, since a machine authentication is not normally finished in the mass-produced information processing device 1 to which the test program P2 is installed, the internal data reference function cannot be run.

The above-described information processing device 1 may be configured such that once the mass-production program P1 is installed in the program area 16a, a machine authentication is required to update the program. According to this configuration, unless a measure to avoid a machine authentication is taken, it is difficult to install the test program P2 in the mass-produced information processing device 1. Therefore, a fraud act won't be easily allowed on the mass-produced information processing device 1 with installation of the test program P2.

The above-described information processing device 1 may be configured such that once the mass-production program P1 is installed in the program area 16, a machine authentication is required to run the security function or to access the data area 17. According to this configuration, in the mass-produced information processing device 1 in which the test program P2 is installed, unless a measure to avoid a machine authentication is taken, the security function cannot be run and the data area 17 cannot be accessed. Therefore, a fraud act won't be easily allowed on the mass-produced information processing device 1 with installation of the test program P2.

The above-mentioned information processing device 1 may be configured such that, if the test program P2 is installed in the program area 16, the operation thereof may be halted. According to this configuration, unless a measure to avoid the operational halt of the information processing device 1, which will be caused by the installation of the test program P2, a fraud act won't be easily allowed on the mass-produced information processing device 1 by installation of the test program P2.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed:

1. An information processing device comprising:
a data memory configured to store a security datum;
a program memory configured to store a processing program; and
a processor configured to execute the processing program;
wherein the processing program requires the security datum to execute the processing program;
wherein the security datum is stored at a memory address in the data memory;
wherein the program memory is configured to store a reference address table linking the security datum with the memory address in the data memory at which the security datum is stored;
wherein the processor is configured to, when executing the processing program, access the reference address table to identify the memory address of the security datum corresponding to the processing program, access the required security datum at the memory address, and execute the processing program; and
wherein the reference address table is different from a second reference address table in a second information processing device.

2. The information processing device of claim 1, wherein the security datum is one of a plurality of security data stored in the data memory;
wherein the processing program is one of a plurality of processing programs stored in the program memory;
wherein the first processor is configured to execute the plurality of processing programs;
wherein each processing program of the plurality of processing programs requires a corresponding security datum of the plurality of security data to execute the processing program;
wherein each security datum of the plurality of security data is stored at a different memory address in the data memory; and
wherein the reference address table links each security datum of the plurality of security data with its corresponding memory address in the data memory.

3. The information processing device of claim 1, wherein the information processing device is a test information processing device for testing prior to deployment in a consumer setting.

4. The information processing device of claim 1, wherein the security datum comprises a security key.

5. The information processing device of claim 1, wherein the security datum comprises authentication data.

6. The information processing device of claim 3, wherein the second information processing device is an information processing device for deployment in a consumer setting.

7. An information processing system for preventing fraud, the information processing system comprising:
a first information processing device comprising:
a first data memory configured to store a security datum;
a first program memory configured to store a processing program;
a first processor configured to execute the processing program;
a second information processing device comprising:
a second data memory configured to store the security datum;
a second program memory configured to store the processing program;
a second processor configured to execute the processing program;
wherein the processing program requires the security datum to execute the processing program;
wherein the security datum is stored at a first memory address in the first data memory and at a second memory address in the second data memory, the second memory address being different from the first memory address;
wherein the first program memory is configured to store a first reference address table linking the security datum with the first memory address;
wherein the second program memory is configure to store a second reference address table linking the security datum with the second memory address;
wherein the first reference address table is different from the second reference address table;
wherein the first processor is configured to, when executing the processing program, access the first reference address table to identify the first memory address of the security datum corresponding to the processing program, access the required security datum at the first memory address, and execute the processing program; and
wherein the second processor is configured to, when executing the processing program, access the second reference address table to identify the second memory address of the security datum corresponding to the processing program, access the required security datum at the security memory address, and execute the processing program.

8. The information processing system of claim 7, wherein the security datum is one of a plurality of security datum stored in each of the first data memory and the second data memory;
wherein the processing program in one of a plurality of processing programs stored in each of the first program memory and the second program memory;
wherein the first processor and the second processor are configured to execute the plurality of processing programs;
wherein each processing program of the plurality of processing programs requires a corresponding security datum of the plurality of security data to execute the processing program;
wherein each security datum of the plurality of security data is stored at a different first memory address in the first data memory;
wherein each security datum of the plurality of security data is stored at a different second memory address in the second data memory;
wherein the first reference address table links each security datum of the plurality of security data with its corresponding first memory address in the first data memory; and
wherein the second reference address table links each security datum of the plurality of security data with its corresponding second memory address in the data memory.

9. The information processing system of claim 7, wherein the first information processing device is a test information processing device for testing prior to deployment in a consumer setting.

10. The information processing device of claim 7, wherein the security datum comprises a security key.

11. The information processing device of claim 7, wherein the security datum comprises authentication data.

12. The information processing device of claim 9, wherein the second information processing device is an information processing device for deployment in a consumer setting.

13. A method for preventing fraud in an information processing device, the method comprising:
providing an information processing device comprising:
a data memory configured to store a security datum;
a program memory configured to store a processing program; and
a processor configured to execute the processing program;
storing a security datum a memory address in the data memory;
storing a processing program in the program memory, the processing program requiring the security datum in order to be executed;
storing a reference address table in the program memory, the reference address table linking the security datum with the memory address at which the security datum is stored;
accessing, with a processor, the reference address table to identify the memory address of the security datum corresponding to the processing program;
accessing, with a processor, the required security datum at the memory address;
executing, with a processor, the processing program; and
wherein the reference address table is different from a second reference address table in a second information processing device.
